(19) United States
(12) Patent Application Publication
(10) Pub. No.: US 2008/0166173 A1
(43) Pub. Date: Jul. 10, 2008

(54) Mobile marking board implement holder

(76) Inventor: Kevin Augustine Gibbons, Colorado Springs, CO (US)

Correspondence Address: Kevin A. Gibbons, 4210B East Muledeer Drive, USAF Acadamy, CO, 80840, US

(21) Appl. No.: 11/649,525

(22) Filed: Jan. 5, 2007

(51) Int. Cl. B43K 23/02

(52) U.S. Cl. 401/131

(57) ABSTRACT

A one-piece, molded holder is provided for dry-erase markers and other presentation aids. This mobile implement holder provides easy, continuous access and storage of multiple color markers and other presentation/teaching aids while actively presenting or instructing. The light-weight holder provides for hand grip allowing single-handed support while the other hand is used in active teaching. The holder secures marker caps allowing quick removal, use, and replacement of markers while caps remain in place on the holder. Additional holes exist in the holder for storing on a nail near a marking board. A magnet(s) is integrated allowing for mounting to a magnetic white board. A straight edge for drawing straight lines on marking boards and an integral eraser allow for easy access during presentations. Fastener strips allow remote presentation slide advancer, remote electronic computer mouse, laser pointer, and the like to attach to the holder for ease of use during presentations.

### CROSS-REFERENCE TO RELATED APPLICATIONS

Not Applicable

### STATEMENT REGARDING FEDERALLY SPONSORED RESEARCH OR DEVELOPMENT

The research and development of this product was not federally sponsored.

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The present invention relates to a mobile implement holder for marking boards, and is particularly concerned with an easy-access implement holder for dry-erase boards commonly called white boards. This mobile holder allows for convenient, quick access to multiple implements when the user is actively presenting or teaching as well as easy “keep together” storage of presentation or teaching implements when not actively in use.

2. Description of the Prior Art

Dry-erase boards are commonly used in situations where large-scale transfer of information is required. The markers and erasers used in conjunction with such boards are generally kept on horizontal ledges or in a fixed-position marker/eraser holder that is adhesively fixed to a section of or near the white board.

During presentations or teaching that involve using several different color implements to convey information effectively, users are typically forced to either hold multiple markers in one hand while writing with the other, which typically results in dropping the implements, or forced to walk away from the area of the board where actively presenting in order to retrieve or lay down one or more of these implements. Time is also spent searching for and retrieving the desired marker color or a real-time compromise to not use a different color is made due to the inconvenience of retrieving these markers.

In addition, when using white board implements, users are forced to remove marker caps which often fall to the floor or are misplaced while actively presenting; especially if multiple color implements are being used for effect. Picking up or searching for marker caps while presenting is inefficient and causes considerable disruption while presenting or teaching.

Moreover, the spontaneous need for quick access to a white board eraser as well as a straightedge by presenters and teachers while actively presenting material requires the user to not only put down the multiple writing implements currently in use but again walk away from the area of the board where actively presenting to retrieve or lay down these additional implements.

These identified issues are currently aggravated by presentation or classroom scenarios where multiple white boards are used, forcing users to walk considerable distances to retrieve implements. The distance and associated time to retrieve implements cause presentation interruption, especially in larger classrooms with multiple white boards and therefore larger distances.

These issues are again compounded by using laser pointers or computer assisted slide presentation devices in conjunction with active white board usage to maximize the presentation/learning environment. A remote slide advancement device, a remote computer mouse, or laser pointers are other teaching implements that require quick, convenient access for effective use in the classroom or presentation environment—yet currently require users to inconveniently recap and stow writing implements for usage. Often these additional implements are placed down somewhere in the classroom to allow for using markers, only to ‘lose’ them temporarily and cause considerable disruption while locating them during presentations or lectures.

A search of the prior art did not disclose any patents that read directly on the claims of the instant invention; however, the following U.S. patents are considered related:

| U.S. Pat. No. | Inventor | Issued |
|---|---|---|
| 9,960,039 B2 | Sieling et al. | 1 Nov 2005 |
| 6,802,665 B2 | Brown | 12 Oct 2004 |
| 6,663,305 B2 | Poulos | 16 Dec 2003 |
| 6,033,139 | Dutcher | 7 Mar 2000 |
| 4,875,591 | Mikesell | 24 Oct 1989 |
| 67,120 | Jedamski | 23 Jul 1864 |

### BRIEF SUMMARY OF THE INVENTION

The object of the present invention is to organize and provide mobile, immediate access to multiple, colored, dry-erase markers, a dry-erase eraser, and other teaching or presenting aids.

The above object is achieved, according to the present invention, in that a lightweight, mobile, single-hand-graspable holder is provided which comprises a number of round cavities or functional holes used to retain respective marker caps and an integral precision eraser. All functional holes for securing marker caps are dimensioned such that marker caps are frictionally restrained within the cavities.

Additionally, the holder dimensions between writing implements are set to allow easy grip and removal of each implement while the cap remains securely in place on the holder. This structure eases marker removal while permitting ambidextrous use. The integral eraser is positioned on the holder such that it can be easily used for erasing while keeping the current writing implement in the user's writing hand. The eraser has a removable and replaceable slide-on cap that covers the eraser so that once capped, any dry-erase residue on the eraser can not soil other objects that the eraser comes into contact with, especially backpacks or laptop bags that the mobile implement holder may be transported in.

According to a particular feature of the invention, the holder incorporates functional holes for hanging/storing the holder with markers on a hook, nail, or screw. The holder also incorporates a flat magnetic strip for affixing the holder to a metallic (ferrous) supporting surface such as anywhere on a magnetic white board.

Although the holder is intended for use with white board markers, such as the EXPO® markers manufactured by Sandford® Corp. Bellwood, Ill.; the holder can also be dimensioned for other manufacturer's writing implements. The caps of the white board implements can be roughened with sandpaper and bonded to the holder with epoxy for added security in addition to the mechanical retention provided by the interference fit.

### BRIEF DESCRIPTION OF THE SEVERAL VIEWS OF THE DRAWING

Other objects, features and advantages of the invention, its organization, construction and operation will be best understood from the following description, taken in conjunction with the accompanying drawing, on which:

FIG. 1 is a top perspective view of the mobile implement holder, constructed in accordance with the present invention, shown in its basic form. The implement holder is designed such that marking board implements and teaching aids can be affixed so that they can be carried and stored in an organized, readily available manner to the presenter or teacher who uses multiple implements while actively presenting material.

FIG. 2 is a top perspective representation of the mobile implement holder, constructed in accordance with the present invention, shown in use with all marking implements stowed and without an attached remote presentation slide advancer/laser pointer.

FIG. 3 is a pictorial representation of a mobile implement holder, constructed in accordance with the present invention, shown in use with a marking board whereby one writing implement has been removed for use while its cap remains securely fixed to the holder. The holder, shown held in the user's left hand while the user is writing with the right hand, is shown with an optional remote presentation slide advancer and combination laser pointer temporarily affixed to the center of the implement holder via adhesively attached hook and loop fastener strips.

FIG. 4 is a top perspective view the mobile implement holder shown with marking implement caps installed in the functional recesses of the holder but without the marking implements in their respective caps.

FIG. 5 is a top perspective view the mobile implement holder shown with a representative teaching aid attached to the center of the holder with hook and loop fastener. The sketched combination teaching aid is a three-way remote electronic computer mouse, remote electronic presentation slide advancer, and a laser pointer.

FIG. 6 is a pictorial representation of the mobile implement holder with the eraser cover partially removed by sliding it off to expose the dry-erase eraser material underneath.

FIG. 7 is a pictorial representation of the mobile implement holder with the eraser cover completely removed by sliding it off to completely expose the dry-erase eraser.

FIG. 8 is a pictorial representation of the mobile implement holder with the eraser cover (removed from the eraser to expose it for use) partially stored on the end of the holder opposite the eraser by sliding it onto the end of the holder.

FIG. 9 is a pictorial representation of the mobile implement holder with the eraser cover (removed from the eraser to expose it for use) totally stored on the end of the holder opposite the eraser by sliding it completely onto the end of the holder.

FIG. 10 is a sectional view taken substantially along the line X-X of FIG. 1.

FIG. 11 is a sectional view taken substantially along the line XI-XI of FIG. 1.

FIG. 12 is a pictorial representation of multiple mobile implement holders, constructed in accordance with the present invention, shown mounted on a supporting surface (magnetic white board or ferrous metallic white board frame) using the magnetic strip as well as mounted on a supporting surface near the white board using one of the functional holes in conjunction with a nail (screw or hook).

FIG. 13 is a bottom plan view of a mobile implement holder, constructed in accordance with the present invention, to show the adhesively-mounted magnetic strip for mounting on a ferrous surface and adhesively-mounted hook and loop fastener strip for holding the eraser cover when installed by sliding onto the end for cover storage during active eraser usage.

### DETAILED DESCRIPTION OF THE INVENTION

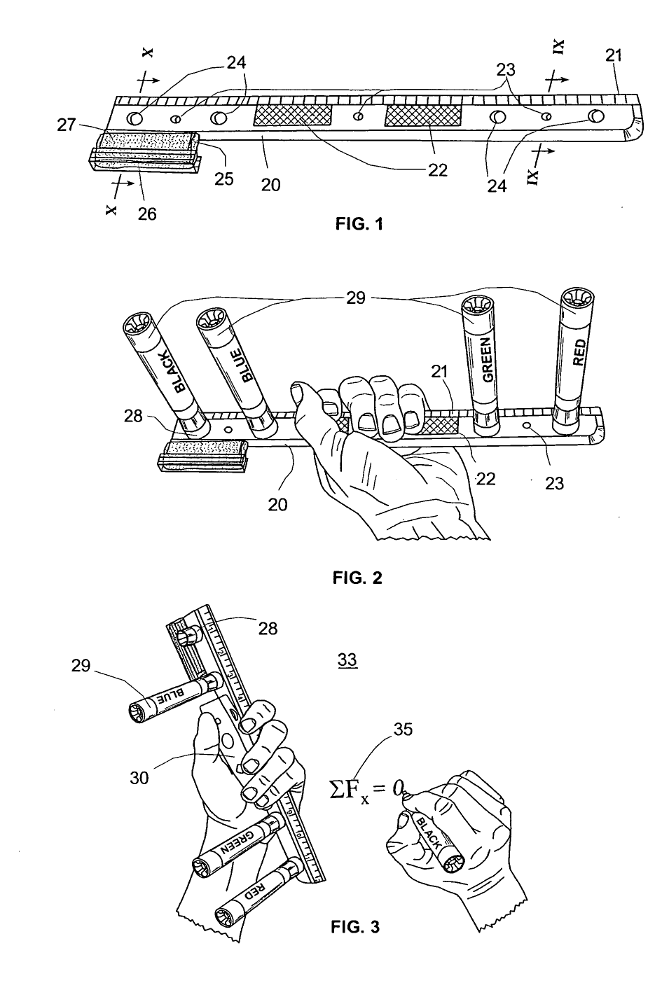

Referring to FIG. 1 and FIG. 2, a mobile implement holder is generally illustrated at 20 as being supported by a single hand of the user. As shown in FIG. 3, gripping the mobile implement holder in one hand (either left or right), allows the user's second hand free to use a marking board implement to write instructional or presentation information 35 onto a marking board 33 as is typically used in a classroom.

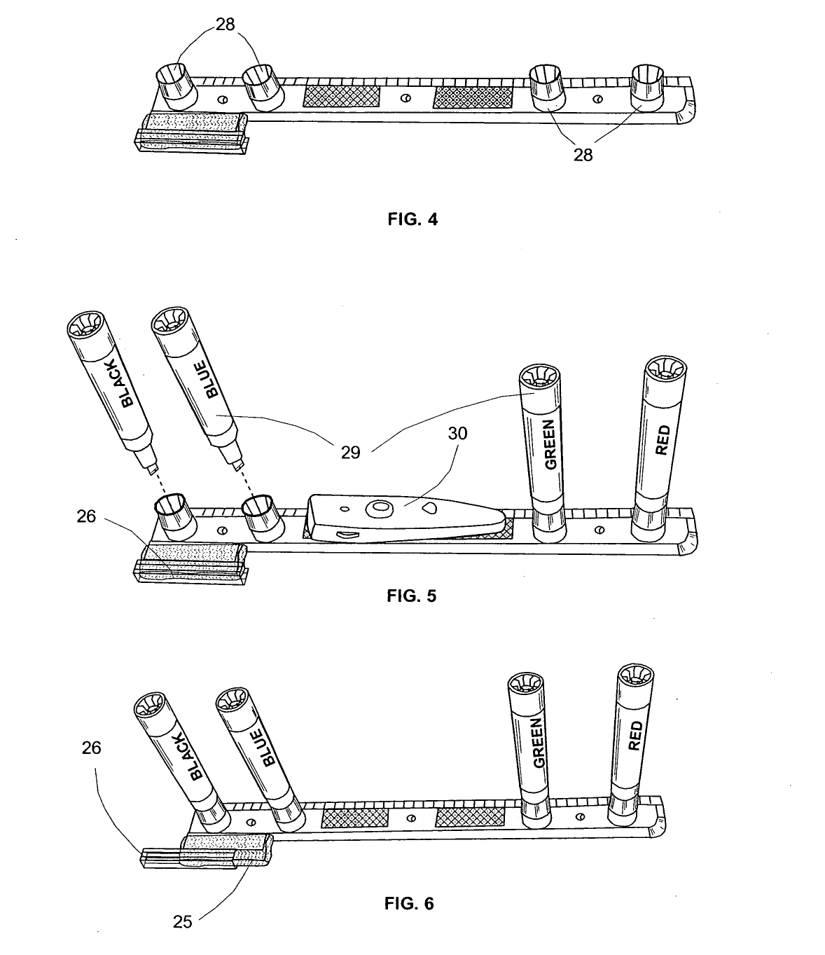

As shown in FIG. 1, the mobile holder comprises a bar with four functional recesses 24 for holding marking implement caps of multiple color dry-erase marking implements. FIG. 2 shows the marking implements with caps 29 installed in the inference fit functional recesses. FIG. 4 shows the marking implement caps only installed in the mobile holder. As is evident from FIGS. 1 and 2, the holder 20 is a thermoformed or injection-molded product of any suitable thermoplastic and incorporates draft angles ranging from between 1 and 2 degrees to allow release from the forming tool during fabrication. Secondary processing can be used to fit (slide in) the dry-erase eraser 25 material and a separately formed or molded eraser cap 26. The marking implement caps 28, mechanically retained by the interference fit within the functional recesses, could be installed into the mobile implement holder by the user and could be held more firmly by using sandpaper to roughen the cap then a two-part epoxy or similar adhesive glue when installing caps into the holder. Marker cap support tabs could be molded into the functional recesses 24 to assist in holding the marker caps more securely or mechanical fasteners installed.

Referring to FIGS. 1 and 2, the holder comprises a straight edge 21 to be used to assist the user in drawing straight lines on a white board while presenting.

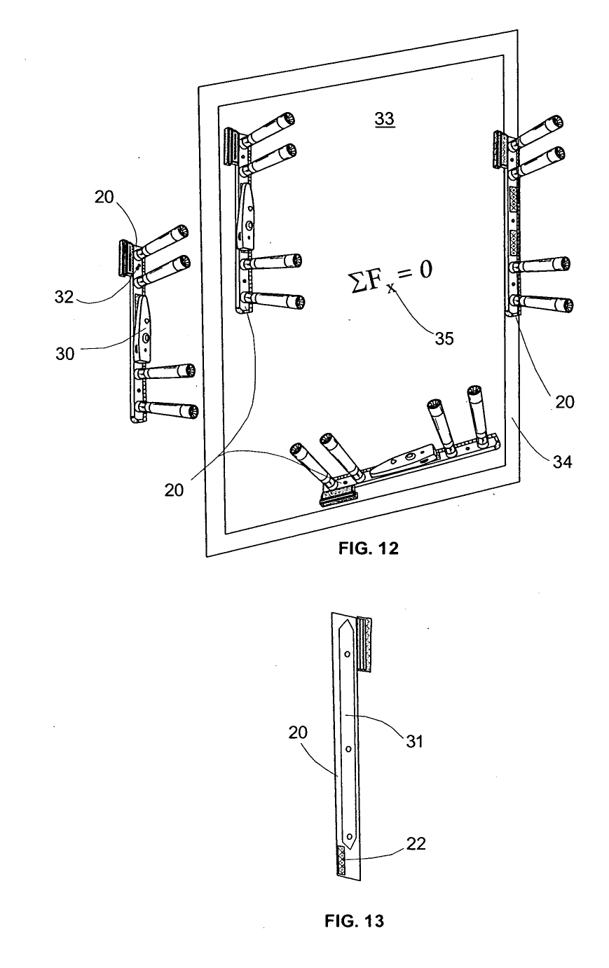

FIGS. 1 and 2 show functional through-holes 23 for hanging the mobile implement holder on a nail, screw, or hook. FIG. 12 shows a nail 32 being used to hang the mobile implement holder 20 near the marking board 33 for storage.

Referring to FIGS. 1 and 13, the adhesively attached hook and loop fastener strips (hook side) 22 could be used to affix teaching or presentation aids. FIG. 5 shows a sketched example combination teaching aid 30 (a three-way remote electronic computer mouse, remote electronic presentation slide advancer, and a laser pointer) attached to the center portion of the mobile holder via these hook and loop fastener strips. The combination teaching aid has hook and loop fastener strips (loop side) attached to mate with the strips (hook side) affixed to the mobile implement holder.

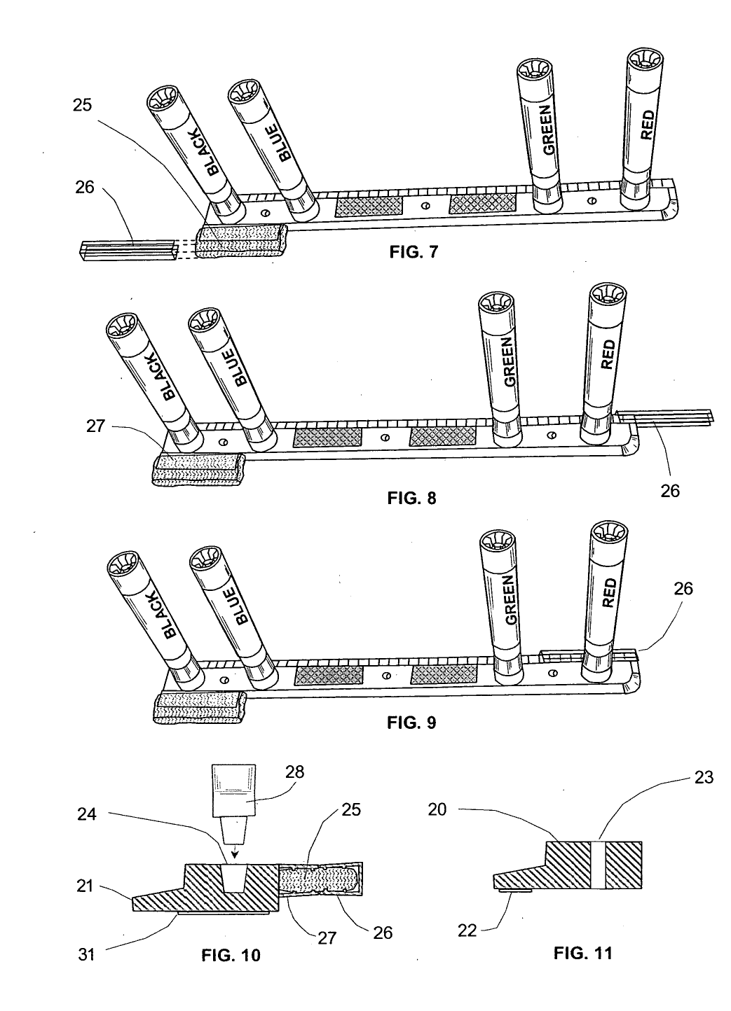

FIG. 1 shows the mobile implement holder with an integral dry-erase eraser composed of a molded plastic eraser material holder 27, the dry-erase eraser material 25, and a molded plastic, slide-off eraser cover 26. FIG. 10 shows a cross section (section X of FIG. 1) view of this eraser. FIGS. 6 and 7 show the eraser cover partially removed and fully removed respectfully. FIGS. 8 and 9 show the eraser cover partially installed and fully installed on opposite end of the holder for storage of the cover when the eraser is in use. The eraser cover is held in place by a frictional fit on the straight edge side of the implement holder. FIG. 11 shows a cross section (section XI of FIG. 1) view with an adhesive hook and loop fastener strip (hook side) 22 as also shown in FIG. 13. This strips purpose is to augment the mechanical retention of the eraser cover when stored on the straight edge side of the mobile implement holder. The cover is stored by sliding it onto the straight edge side of the mobile implement holder, pushing against, and therefore held frictionally against, the hooks of the hook and loop fastener strip.

Referring to FIG. 13, the adhesively attached magnetic strip 31, could be installed. This magnetic mounting strip is used to stow the mobile implement holder on a magnetic white board 33 or on a ferrous metal white board frame 34. FIG. 12 shows the holder mounted magnetically on both a magnetic white board 33 and the ferrous white board frame 34 for storage when not in use.

Although I have described my invention by reference to particular illustrative embodiments thereof, many changes and modifications of the invention may become apparent to those skilled in the art without departing from the spirit and scope of the invention. For example, this mobile marking board implement holder's functional holes can be sized or molded in other geometric designs consistent with other dry-erase or liquid marker designs, as well as chalk, pens, and other forms of marking implements. I therefore intended to include within the patent warranted hereon all such changes and modifications as may reasonably and properly be included within the scope of my contribution to the art.

I claim:

1. A mobile implement holder for primarily holding marker caps (with associated markers) and secondly holding presentation/teaching implements for ease of access during presentations, comprising:
a) a one-piece, molded plastic, light-weight structure with functional recesses that firmly holds marking board implement caps (keeping associated markers exposed) allowing for easy, multiple-color marking implement access, removal from cap, and replacement into cap during active presenting or teaching, including:
b) a single-handed grip section to provide convenient mobility of implement holder when actively using it during presentations or while teaching;
c) an integral straight edge for mobile, easy-access and assisting in drawing straight lines on marking boards while actively presenting; and
d) functional through-holes for mounting and storing the holder with implements on a nail, screw or hook proximal to the marking board.

2. The mobile implement holder as specified in claim 1 constructed from wood.

3. The mobile implement holder as specified in claim 1 or 2 with an integrally molded or attached precision eraser for easy dry-erase eraser access while actively presenting; could include an eraser cover to prevent eraser residue from soiling objects that come in contact with the used eraser while storing, transporting, or not actively erasing.

4. The mobile implement holder as specified in claim 1 or 2 with an integral magnetic strip, or similar integral magnet, for magnetically mounting and storing the holder on metallic (ferrous) objects, to include magnetic white boards, for easy-access storage of holder with implements.

5. The mobile implement holder as specified in claim 1 or 2 with an optional integral hook and loop fastener strip, or similar fastener, for affixing a laser pointer, ink pens or other writing implements, a remote control presentation slide advancer, a remote control electronic computer mouse, or other similar presentation/teaching aids where easy-access is desired while presenting information.
